(19) United States
(12) Patent Application Publication
(10) Pub. No.: US 2012/0113131 A1
(43) Pub. Date: May 10, 2012

(54) METHOD AND APPARATUS FOR GENERATING A SEQUENCE OF A PLURALITY OF IMAGES

(75) Inventor: Marc Andre Peters, Eindhoven (NL)

(73) Assignee: KONINKLIJKE PHILIPS ELECTRONICS N.V., EINDHOVEN (NL)

(21) Appl. No.: 13/382,315

(22) PCT Filed: Jun. 30, 2010
(86) PCT No.: PCT/IB2010/052986

§ 371 Date: Jan. 5, 2012

(30) Foreign Application Priority Data
Jul. 6, 2009 (EP) 09164647.1

(51) Int. Cl. G09G 5/02

(52) U.S. Cl. 345/590

(57) ABSTRACT

A method of generating a sequence of a plurality of images to be displayed with ambient lighting, the method comprising the steps of: extracting 201 at least one feature of each of a plurality of images; selecting 203 ambient lighting to be displayed with each of said plurality of images on the basis of said extracted at least one feature; determining 205, 207, 209, 211, 213 an order for display of said plurality of images on the basis of said selected ambient lighting to provide a smooth transition in changes in said ambient lighting during display of said plurality of images according to said order.

### FIELD OF THE INVENTION

The present invention relates to a method and apparatus for generating a sequence of a plurality of images. In particular it relates to a method and apparatus for generating a sequence of a plurality of images to be displayed with ambient lighting.

### BACKGROUND TO THE INVENTION

A sequence of still digital images is often used for presentations, or for atmospheric display. Sometimes the ordering of those images is such to tell a story, where on other occasions the images are ordered to match an ambience. An example is a digital photo frame connected to an ambient light source (like a LivingColors lamp); where for each image the ambient light is automatically adjusted to match with the current image being displayed. The matching could be based on the most dominant colour of an image, or the colour of the ambient lighting or light source reflected in the image results in an ambient lighting that is appealing.

For example the most dominant colour of an image may be dark blue (25%), and the next dominant colors have less than 13% contribution. However the light source or ambient light reflected in the image, for example the sun reflecting on the scene, may alter the colours of features within the image. Therefore the colour of the sun reflection may be used as the colour for the LivingColors lamp, enhancing the atmosphere in the room even though this may not be the most dominant colour of the image. In determining the colour of the light source, if this is reflected on a white surface, the reflected colour will correspond to the colour of the light source. However, even in cases where the light source is not obvious, for example white light source reflecting on a colour surface, light source detection results in one of the brighter dominant colours, which gives a very natural effect during display of the image.

However the order of display of the images is such that it may tell a story or may be ordered in the order that they were captured etc. As the ambient lighting automatically changes with the change in display of each image, this often results in dramatic changes in the light output of the ambient light source, resulting in a very wild and unpleasant effect, like a flickering disco effect, for example.

### SUMMARY OF INVENTION

The present invention seeks to provide ordering image for display with ambient lighting such that the viewer's experience is enhanced.

This is achieved, according to one aspect of the present invention, by a method of generating a sequence of a plurality of images to be displayed with ambient lighting, the method comprising the steps of: extracting at least one feature of each of a plurality of images; selecting ambient lighting to be displayed with each of the plurality of images on the basis of the extracted at least one feature; determining an order for display of the plurality of images on the basis of the selected ambient lighting to provide a smooth transition in changes in the ambient lighting during display of said plurality of images according to the order.

This is also achieved, according to a second aspect of the present invention, by apparatus for generating a sequence of a plurality of images to be displayed with ambient lighting, the apparatus comprising: an extractor for extracting at least one feature of each of a plurality of images; a selector for selecting ambient lighting to be displayed with each of the plurality of images on the basis of the extracted at least one feature; and a processor for determining an order for display of the plurality of images on the basis of the selected ambient lighting to provide a smooth transition in changes in the ambient lighting during display of the plurality of images according to said order.

When ordering images, the smooth transition between the changes in the ambient lighting provides a very appealing effect and avoids excessive flickering of light and dramatic changes in light which can be distracting and unpleasant to the viewer.

In an embodiment, the extracted at least one feature comprises colour and the ambient lighting to be displayed with each of said plurality of images is selected having a colour corresponding to the most dominant colour of each of the plurality of images, or alternatively, having a colour corresponding to the colour of the light source reflected in the image.

In this way, existing techniques can be utilized to select the ambient lighting to be used during display.

In an embodiment, the order for display of the plurality of images is determined by converting the colour of the selected ambient lighting to HSV colour space; and determining a first order for display of the plurality of images such that changes in colour of the selected ambient lighting are in accordance with the hue circle; and ordering the plurality of images according to the determined first order.

The hue of any colour has a hue value. The hue value is an angular value, normally represented as a number in the interval [0,360). This defines a hue circle representing each hue value. Using any arbitrary starting point, the colours of the ambient light source and hence the images are ordered to follow the hue circle.

In this way, each image is represented by a colour and are ordered based on the hue of that color. This provides a smooth transition in the changes of the colour of the ambient lighting enhancing the display in making it more pleasing.

In addition, the order for display of the plurality of images may be determined on the basis of reordering the order for display of the plurality of images at least once such that changes in colour of said selected ambient lighting are in accordance with the hue circle for images having a saturation and/or value meeting a predetermined condition, for example, reordering such that changes in colour of the selected ambient lighting are in accordance with the hue circle for images having a saturation and value greater than a first predetermined value, and/or reordering the plurality of images such that changes in colour of the selected ambient lighting are in accordance with the hue circle for images having a saturation and value within a range of the first predetermined value and a second predetermined value. The first predetermined value may be greater than the second predetermined value.

On a second level, the saturation and value are taken into account, creating a spiral effect through the HSV colour space. The result is a very appealing ordering of the images.

The viewing effect may be further improved by excluding images for display having a saturation and value of less than a predetermined threshold, i.e. dark images or images having a very low saturation which may be less interesting when displayed with ambient lighting.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for generating a sequence of images for display according to an embodiment of the present invention; and

FIG. 2 is a flowchart of a method of generating a sequence of images for display according to an embodiment of the present invention.

### DETAILED DESCRIPTION OF EMBODIMENTS OF THE INVENTION

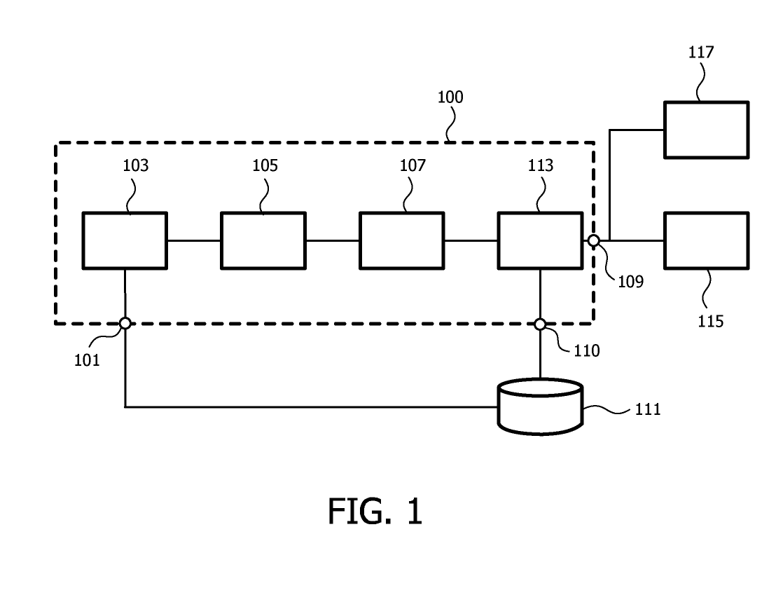

With reference to FIG. 1, the apparatus 100 comprises a first input terminal 101 connected to the input of an extractor 103. The output of the extractor 103 is connected to the input of a selector 105. The output of the selector 105 is connected to the input of a processor 107. The output of the processor 107 is connected to the input of a controller 113. A second input of the controller 113 is connected to a second input terminal 110 of the apparatus 100. The output of the controller 113 is connected to an output terminal 109 of the apparatus 100.

The first and second input terminals 101, 110 of the apparatus 100 are connected to storage means 111. Although the storage means 111 is illustrated here as external to the apparatus 100, in an alternative embodiment, the storage means 111 may be integral with the apparatus. The storage means 111 may be a memory device of a computer system, such as a ROM/RAM drive, CD, a memory device of a camera, digital photo frame or like device connected to the apparatus 100, or remote server. It may be accessed via a wired or wireless connection and/or accessed via a wider network such as the Internet. The storage means 111 stores a plurality of images. Images stored on a remote server, for example, may be uploaded and temporarily stored in a local storage means (not shown here) of the apparatus 100.

The output terminal 109 of the apparatus 100 is connected to a display 115 and an ambient light source 117. The display 115 may be a display of a PC, digital photo frame, display of a digital camera and/or a projector and projector screen, or a television screen or the like. The ambient light source 117 may be a LivingColors lamp or an array of coloured light sources or the like.

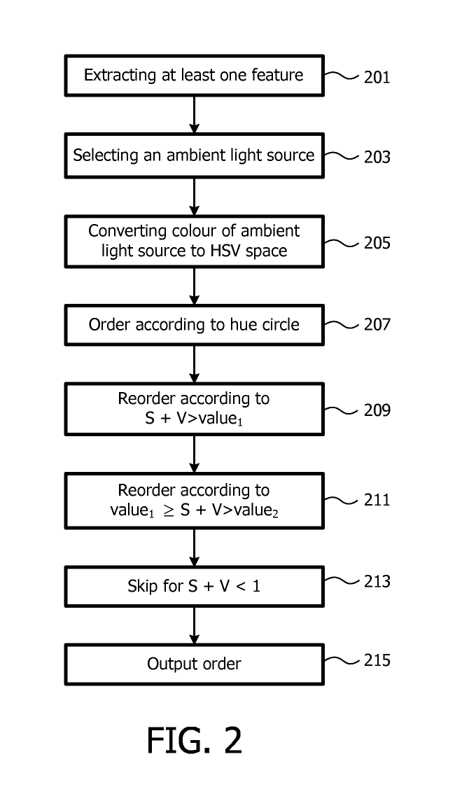

Operation of the apparatus of FIG. 1 will now be described with reference to FIG. 2.

A plurality of images for display are retrieved from the storage means 111 and input via the input terminal 101 into the extractor 103. For each image, the extractor extracts at least one feature such as percentage contribution made by colours within each image or the colour caused by reflection of a light source in the image, step 201. On the basis of the most dominant colour, for example, the colour having the highest percentage contribution or on the basis of the colour caused by reflection of a light source, the colour of ambient lighting to accompany the image is selected, step 203, by the selector 105.

A known technique called principal component analysis (PCA) can be used in the method for determining the light source entering a scene. The idea behind the light estimation procedure (which can also be used for purposes other than generating a sequence of a plurality of images to be displayed with ambient lighting) is that light entering an image will be reflected on the white parts of the image. All the pixels in the image will be colored in the color of the light source, according to the luminance. Now, the method takes all the pixels of the image, and looks at them in a 3 dimensional cube in a (linear) RGB space. PCA does the following: starting from the average RGB values as a point of origin, the axes are transformed into 3 new axes in such a way that the first axis (the principal component) is responsible for most of the variation in the set of pixels. The principal axis can also be regarded as the result of least squares estimation. The final step is to estimate the point on the principal axis that corresponds to the actual light source. This can be done by projecting the pixels on the principal axis and check where the contribution is significant (i.e. avoid taking a single pixel because it might be there because of encoding). The result is the light source entering the scene in the image. The light source itself is not visible in the image. In case there is no light source available, the algorithm will yield the most dominant color of the image, which is very reasonable and looks very natural. This can be done for parts of an image as well to find light sources for a region of interest.

For each of the images for display, the processor 107 converts the colour of the selected ambient lighting to the HSV color space, that is, the hue as defined by the HSV colour space (Hue Saturation Value) for that colour, step 205.

The hue of any colour has a hue value. The hue value is an angular value, normally represented as a number in the interval [0,360). This defines a hue circle representing each hue value. Using any arbitrary starting point, the colours of the ambient light source and hence the images are ordered to follow the hue circle, step 207. When the atmosphere (the LivingColors lamp) follows the images, the atmosphere slowly follows the hue circle as well, providing a smooth transition of changes in the ambient lighting.

To further improve the transition between changes in the colours of the ambient light source, the 3-dimensional nature of the colour is taken into account. The images are then reordered, step 209 using components of saturation and value of the colour.

As a result the sequence of images may be reordered a predetermined number of times. Although the embodiment illustrates reordering twice, steps 209, 211, it can be appreciated that this may be carried any number of times for different values and ranges to give the required smooth transition. In each reordering cycle a condition on the saturation and/or value is imposed. For example, with saturation and value both being in the interval [0,1], the first reorder cycle through the hue circle for all the images may have the condition

saturation+value>1.7

As a result, images having a high saturation and value are grouped together.

In step 211, the images are reordered through the hue circle for all the images having the condition

1.7≧saturation+value>1.4

And more iteration may follow. As a result, the reordering is repeated several times, but with colours that also have a reasonable match on the components saturation and/or value. As a result the smooth transition in the change of colour of the ambient lighting is further improved and the atmosphere is adjusted to match the display in a very subtle and pleasing way. Reordering means that the order in the presentation is changed. The order in which the images are stored or the order in a stored list that refers to the images is not necessarily changed. In one embodiment, a stored list that refers to the images is ordered based on hue value and the stored list is then cycled through multiple times based on saturation and value.

This results in the display of images being more dynamic in the sense that each hue will appear several times during the display, where in the previous case in which the images were ordered following the hue circle only, a colour would appear once for a time interval as the images would be grouped according to their hue.

Where the basis is that transitions follow the hue circle, of course more sophisticated conditions on the saturation and value can be used to improve the final result, for example,

min(saturation, value)>0.7 AND

max(saturation, value)<0.9

Additionally, the method can be used to leave out less interesting images. In this case less interesting images are referred to as those images that do not match with a colour that can easily be used to enhance the ambience. For example dark images or images with very low saturation, step 213. For example, images that have

saturation+value<1

The order of the images is then output, step 215, by the processor 107 to the controller 113. The controller 113 then retrieves the images from the storage means via the second input terminal 110 and controls the display 115 and the ambient light source 117 to provide a display of the images and lighting according to the order. The colours of the ambient lighting are very appealing for use in light effects, and the transitions between the colors are relatively smooth.

This can be utilized in slideshow presentations, photo frames or the like.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of generating a sequence of a plurality of images to be displayed with ambient lighting, the method comprising the steps of:
extracting (201) at least one feature of each of a plurality of images;
selecting (203) ambient lighting to be displayed with each of said plurality of images on the basis of said extracted at least one feature;
determining (205, 207, 209, 211, 213) an order for display of said plurality of images on the basis of said selected ambient lighting to provide a smooth transition in changes in said ambient lighting during display of said plurality of images according to said order.

2. A method according to claim 1, wherein said extracted at least one feature comprises colour.

3. A method according to claim 2, wherein the step (203) of selecting ambient lighting to be displayed with each of said plurality of images comprises the step of:
selecting ambient lighting having a colour corresponding to the most dominant colour of each of said plurality of images.

4. A method according to claim 2, wherein the step (203) of selecting ambient lighting to be displayed with each of said plurality of images comprises the step of:
selecting ambient lighting having a colour corresponding to the colour of the light source reflected in the image.

5. A method according to claim 2, wherein the step of determining an order for display of said plurality of images comprises the steps of:
converting (205) the colour of said selected ambient lighting to HSV colour space; and
determining (207) a first order for display of said plurality of images such that changes in colour of said selected ambient lighting are in accordance with the hue circle; and
ordering said plurality of images according to said determined first order.

6. A method according to claim 5, wherein the step of determining an order for display of said plurality of images further comprises the steps of:
determining (209, 211) at least one further order for display of said plurality of images in said determined first order such that changes in colour of said selected ambient lighting are in accordance with the hue circle for images having a saturation and/or value meeting a predetermined condition.

7. A method according to claim 6, wherein the step of determining at least one further order for display of said plurality of images further comprises the steps of:
determining (209) a second order for display of said plurality of images in said determined first order such that changes in colour of said selected ambient lighting are in accordance with the hue circle for images having a saturation and value greater than a first predetermined value; and
ordering said plurality of images according to said determined second order.

8. A method according to claim 7, wherein the step of determining at least one further order for display of said plurality of images further comprises the steps of:
determining (211) a third order for display of said plurality of images in said determined second order such that changes in colour of said selected ambient lighting are in accordance with the hue circle for images having a saturation and value within a range of said first predetermined value and a second predetermined value; and
ordering said plurality of images according to said determined third order.

9. A method according to claim 8, wherein said first predetermined value is greater than said second predetermined value.

10. A method according to claim 5, wherein the step of determining an order for display of said plurality of images comprises the step of:
excluding (213) images from said order for display having a saturation and value less than a predetermined threshold.

11. A computer program product comprising a plurality of program code portions for carrying out the method according to claim 1.

12. Apparatus (100) for generating a sequence of a plurality of images to be displayed with ambient lighting, the apparatus (100) comprising:
an extractor (103) for extracting at least one feature of each of a plurality of images;
a selector (105) for selecting ambient lighting to be displayed with each of said plurality of images on the basis of said extracted at least one feature; and
a processor (107) for determining an order for display of said plurality of images on the basis of said selected ambient lighting to provide a smooth transition in changes in said ambient lighting during display of said plurality of images according to said order.

13. Apparatus (100) according to claim 12 further comprising
a controller (113) for controlling a display (115) for displaying said plurality of images according to said determined order, and an ambient light source (117) for generating said selected ambient lighting according to said determined order.
